(19) United States
(12) Patent Application Publication
(10) Pub. No.: US 2025/0091571 A1
(43) Pub. Date: Mar. 20, 2025

(54) System and Method for Predicting Vehicle Safety Events Based on Prior Lane Departure Events

(71) Applicant: RM ACQUISITION, LLC, Boise, ID (US)

(72) Inventor: Andreas U. Kuehnle, Strangnas (SE)

(21) Appl. No.: 18/469,789

(22) Filed: Sep. 19, 2023

(51) Int. Cl. B60W 30/095; B60Q 9/00; B60W 50/14; G06V 20/56; G07C 5/00

(52) U.S. Cl. CPC B60W 30/0953; B60Q 9/008; B60W 50/14; G07C 5/008; B60W 2520/06; B60W 2540/223; B60W 2540/229; B60W 2540/30; B60W 2552/10; G06V 20/56

(57) ABSTRACT

A system for predicting a safety event for a vehicle includes a memory and a controller. The controller is configured to retrieve a dataset from the memory. The dataset includes information about one or more lane departure events in which the vehicle departed a lane of travel for the vehicle and that occurred during a prior period of predetermined length. The information for each event includes a time of the event, a travel distance of the vehicle when the event occurred, and an indication of the extent of departure from the lane of travel by the vehicle. The controller generates a plurality of values characterizing the information in the dataset and generates, responsive to the plurality of values, a score indicative of a likelihood that a safety event for the vehicle will occur. Depending on the score, the controller may generate warnings to the vehicle operator or assist vehicle operation.

### BACKGROUND OF THE INVENTION

### a. Field of the Invention

This invention relates to systems and method for predicting vehicle safety events such as collisions with other vehicles, pedestrians or road infrastructure. In particular, the invention relates to a system and method for predicting vehicle safety events occurring during movement of the vehicle in the longitudinal direction of the vehicle based on previously recorded events relating to movements of the vehicle in lateral direction of the vehicle and, in particular, lane departure events.

### b. Background Art

Vehicle operator fatigue is a significant factor in safety events during vehicle operation such as collisions with other vehicles, pedestrians or road infrastructure. In general, the number of safety events increases significantly the longer an operator operates a vehicle without rest. For this reason, it would be beneficial to be able to determine operator fatigue and provide appropriate warnings or intervention (operator assistance) before a safety event occurs. Although operator fatigue is a good predictor of the likelihood of a safety event, the level of operator fatigue is difficult to measure. Further, the level of operator fatigue among different vehicle operators is dependent on a variety of factors (e.g., the operator's individual health, recent travel and rest history, etc.) and therefore highly variable.

Managers of commercial vehicle fleets typically monitor the operation of vehicles in a fleet in order to assess both the performance of the vehicles and the performance of individual vehicle operators to thereby protect vehicles within a fleet, the loads carried by the vehicles, and people and property within the environments in which the vehicles are operating. A variety of systems have been developed that allow fleet managers to monitor the operation of a vehicle and the behaviors of operators of the vehicle. The applicant Bendix Commercial Vehicle Systems LLC, for example, offers a monitoring system under the registered trademark “SAFETYDIRECT” that collects data from the vehicle and generates information regarding operation of the vehicle and the behaviors of operators of the vehicle. This information can then be used by fleet managers for a variety of purposes including assessing vehicle operators, correcting and/or rewarding operator behavior and tailoring operator education and training to address particular operating habits.

Among other data, the “SAFETYDIRECT” system collects information regarding lane departure events in which the operator unintentionally departs from the lane of travel. Because these events occur relatively frequently, the events provide a large amount of data. In addition, lane departure events can be indicative of operator fatigue with the number and extent of lane departures increasing as operator fatigue increases. The inventor has determined that these lateral movements of the vehicle resulting in lane departure events can be used to approximate and indirectly measure operator fatigue and, as a result, provide information on the likelihood of more significant safety events such as collisions resulting from movement of the vehicle in the longitudinal direction of the vehicle.

The inventor herein has recognized a need for a system and method for predicting vehicle safety events that will minimize and/or eliminate one or more of the above-identified deficiencies.

### BRIEF SUMMARY OF THE INVENTION

This invention relates to systems and method for predicting vehicle safety events such as collisions with other vehicles, pedestrians or road infrastructure. In particular, the invention relates to a system and method for predicting vehicle safety events occurring during movement of the vehicle in the longitudinal direction of the vehicle based on previously recorded events relating to movements of the vehicle in lateral direction of the vehicle and, in particular, lane departure events.

A system for predicting vehicle safety events in accordance with one embodiment includes a memory and a controller. The controller is configured to retrieve a dataset from the memory. The dataset includes information about one or more lane departure events in which the vehicle departed a lane of travel for the vehicle and that occurred during a prior period of predetermined length. The information for each lane departure event includes a time of the lane departure event, a travel distance of the vehicle when the lane departure event occurred, and an indication of the extent of departure from the lane of travel by the vehicle. The controller is further configured to generate a plurality of values characterizing the information in the dataset and to generate, responsive to the plurality of values, a score indicative of a likelihood that a safety event for the vehicle will occur.

A method for predicting vehicle safety events in accordance with one embodiment includes retrieving a dataset from a memory. The dataset includes information about one or more lane departure events in which the vehicle departed a lane of travel for the vehicle and that occurred during a prior period of predetermined length. The information for each lane departure event includes a time of the lane departure event, a travel distance of the vehicle when the lane departure event occurred, and an indication of the extent of departure from the lane of travel by the vehicle. The method further includes generating a plurality of values characterizing the information in the dataset and generating, responsive to the plurality of values, a score indicative of a likelihood that a safety event for the vehicle will occur.

A system and method for predicting vehicle safety events in accordance with the present teachings represents an improvement as compared to conventional systems and methods. In particular, the system and method make use of lateral movements of the vehicle and, in particular, lane departure events, as an indication of operator fatigue in order to predict the likelihood of safety events such as collisions resulting from longitudinal movement of the vehicle.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a diagrammatic view of a vehicle incorporating a system for predicting a vehicle safety event in accordance with the present teachings.

FIG. 2 is a diagrammatic view of a system for predicting a vehicle safety event in accordance with the present teachings.

FIG. 3 is a diagrammatic view of a plurality of datasets including information regarding events occurring at different times within consecutive periods of predetermined length.

FIG. 4 is a diagrammatic view of a dataset including information regarding events occurring at different times within a period of predetermined length.

FIG. 5 is a flowchart illustrating one embodiment of a method for predicting a vehicle safety event in accordance with the present teachings.

FIG. 6 is a graphical representation of the results of one test indicating the relative predictive power in predicting a vehicle safety event of various values characterizing information in a plurality of datasets.

### DETAILED DESCRIPTION OF THE INVENTION

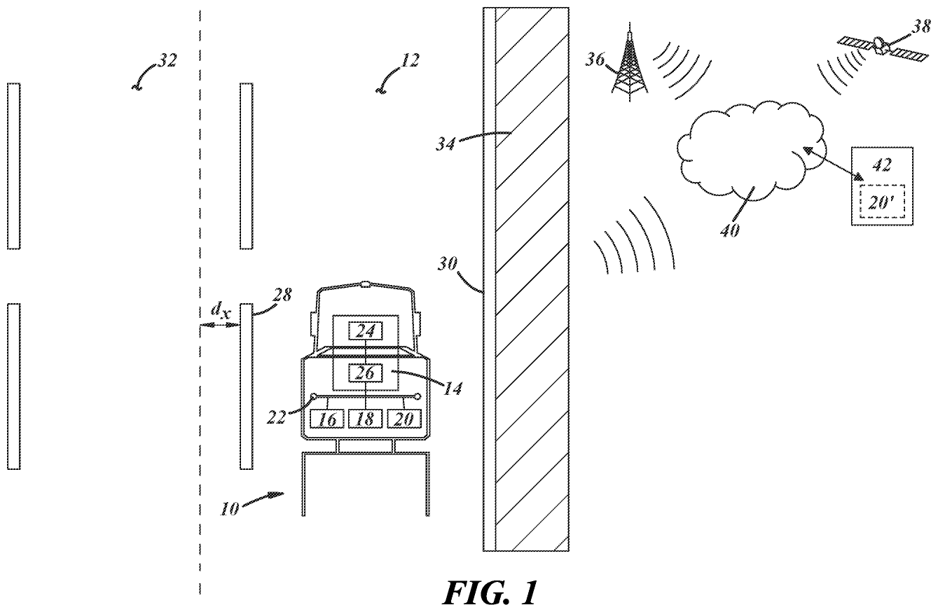

Referring now to the drawings wherein like reference numerals are used to identify identical components in the various views, FIG. 1 illustrates a vehicle 10 incorporating a system for predicting a vehicle safety event for vehicle 10 in accordance with the present teachings. As used herein, a vehicle safety event refers to certain events that occur as a result of movement of vehicle 10 in a longitudinal direction of vehicle 10 or in the direction of a lane of travel 12 of vehicle 10. A vehicle safety event may, for example, include an excessive braking action by the operator of vehicle 10, an emergency braking action by a collision avoidance system or other autonomous emergency braking system, issuance of a forward collision warning to an operator of vehicle 10 regarding a possible collision between vehicle 10 and another vehicle, pedestrian or object as vehicle 10 moves within lane of travel 12, or a loss of stability in vehicle 10 as lane of travel 12 curves. In the illustrated embodiment, vehicle 10 comprises a tractor-trailer (also referred to as a semi). It should be understood, however, that the system and method disclosed herein could be used in other types of vehicles including, for example, other commercial vehicles such as buses or off-road vehicles and in non-commercial vehicles such as automobiles. In addition to conventional systems for use in operating vehicle 10 such as power generating and distribution systems, steering systems, braking systems, access control systems, etc., vehicle 10 may include a lane departure warning system 14, a monitoring system 16 for monitoring the operation of vehicle 10 and the behavior of operators of vehicle 10 and a telecommunications system 18 for transmitting information to, and receiving information from, locations remote from the vehicle 10. In accordance with the present teachings, vehicle 10 further includes a system 20 for predicting a vehicle safety event in vehicle 10 and providing corresponding warnings to the operator or other individuals and/or providing assistance to the operator through control of one or more systems in vehicle 10. Systems 14, 16, 18 and 20 may communicate with one another and with other systems on vehicle 10 over a conventional communications bus 22 such as a controller area network (CAN) or local interconnect network (LIN).

Lane departure warning system 14 is provided to alert the operator of vehicle 10 and, in certain embodiments, operator assistance systems such as a lane keep assistance system, when vehicle 10 unintentionally departs from the lane of travel for vehicle 10. System 14 may include one or more cameras 24 and a camera controller 26. System 14 may identify intentional and unintentional departures from the lane of travel 12 depending on whether the operator has actuated a turn or lane change signal used to signal other vehicles of an impending lane change in combination with a departure from the lane of travel 12.

Camera 24 is configured to capture images of the lane of travel 12 for vehicle 10. The images include lane markers 28, 30 on either side of the lane of travel 12. In the illustrated embodiment, the lane of travel 12 for vehicle 10 is the rightmost lane on a road having multiple lanes traveling in the same direction. Therefore, lane marker 28 is a broken lane marker marking the border between the lane of travel 12 for vehicle 10 and an adjacent lane of travel 32. Lane marker 30 is an unbroken or continuous lane marker marking the border between the lane of travel 12 and an off-road area 34. Camera 24 may comprise a digital camera and may be mounted on the vehicle's windshield. The camera may, for example, comprise the camera forming part of the Auto Vue® Lane Departure Warning System offered for sale by Bendix Commercial Vehicle Systems LLC.

Camera controller 26 is configured to process images generated by camera 24 and to generate, responsive to the images, signals including information obtained from the images. In accordance with the present teachings, camera controller 24 may provide information relating to each lane departure event in which vehicle 10 departs the lane of travel 12. The signals from controller 26 may include an indication that a lane departure event has occurred (e.g., that vehicle 10 has crossed one of lane markers 28, 30) as well as information on the extent of the lane departure. For example, controller 26 may provide the specific distance of a point on the vehicle from the outboard or inboard edge of the lane marker 28 or 30. Alternatively, controller 26 may provide an indication of whether the same point on the vehicle is within or outside of a predetermined distance dx outboard of a lane marker 28, 30 or an indication of whether the same point on the vehicle is within one or more ranges of distance outboard of the inboard or outboard edge of the lane marker 28, 30. Controller 26 may also provide information regarding the time of the lane departure event and the travel distance of vehicle 10 when the lane departure event occurred. Alternatively, information regarding the time of the lane departure event and the travel distance of vehicle 10 when the lane departure event occurred may be obtained from other sources and associated with the lane departure event in, for example, monitoring system 16. Controller 26 may comprise a programmable microprocessor or microcontroller or may comprise an application specific integrated circuit (ASIC). Controller 26 may include a central processing unit (CPU), a memory, and an input/output (I/O) interface through which controller 26 may receive a plurality of input signals and transmit a plurality of output signals over bus 22. The input signals may include image information from camera 24. The output signals may include information obtained from the images captured by camera 24 as set forth above. Controller 26 may, for example, comprise the lane departure warning processor forming part of the AutoVue® Lane Departure Warning System offered for sale by Bendix Commercial Vehicle Systems LLC.

System 16 is provided for monitoring the operation of vehicle 10 and the behavior of operators of vehicles 10. System 16 may, for example comprise the system offered by Applicant under the registered trademark “SAFETYDIRECT” which records safety related events such as speeding, unintentional lane departures detected by system 14, and loss of vehicle stability. System 16 may be configured to gather and record information from a variety of individual sensors on vehicle 10 such as wheel speed sensors, acceleration sensors, yaw rate sensors, and steer angle sensors and from a variety of systems on vehicle 10 such as collision avoidance systems, stability control systems, anti-lock braking systems, tire pressure monitoring systems and lane departure warning system 14. The information may be gathered and recorded in response to specific episodes or events (e.g., those indicating a potential safety risk) and/or on a regular basis (constantly or at predetermined time intervals) without reference to a specific episode or event. System 16 may be configured to process some or all of the information to generate additional information regarding the operation of vehicle 10 and the behavior of operators of vehicle 10. System 16 may provide some or all of the information gathered and/or generated by system 16 to the vehicle operator through one more conventional operator interfaces including display screens, surface projections and audio, visual or haptic indicators. System 16 may also transmit some or all of the information gathered and/or generated by system 16 to locations remote from vehicle 10 through telecommunications system 18 for various purposes including assessment of the operation of vehicle 10 and the behavior of operators of vehicle 10 by fleet managers.

Telecommunications system 18 enables communication between vehicle 10 and other vehicles (V2V communication), road infrastructure (V2I communication) and end users (e.g., fleet managers and vehicle service providers) overs various telecommunications networks. System 18 enables wireless voice and/or data communication over a wireless carrier system and via wireless networking. In some embodiments, system 18 may comprise or form a part of a vehicle telematics unit used to provide a diverse range of services including turn-by-turn directions and other navigation-related services that are provided in conjunction with a GPS-based vehicle navigation system, airbag deployment or collision notification and other emergency or roadside assistance-related services, and diagnostic reporting using information obtained from various vehicle control systems.

System 18 may include a short-range wireless communication transceiver for communicating with systems on vehicle 10 including systems 14, 16 and 20 and for communication with other vehicles and road infrastructure that are configured for communication over a relatively short distance using short-range wireless technologies such as Wi-Fi (IEEE 802.11), WiMAX, Wi-Fi direct, Bluetooth, Zigbee, near field communication (NFC), etc. and that transmit and receive signals through an antenna. The transceiver may be configured to allow vehicle to vehicle communication in accordance with Society of Automotive Engineering (SAE) Standard J2945 directed to Dedicated Short Range Communication. Alternatively, on-board vehicle systems such as systems 14, 16 and 20 may communicate with system 18 over bus 22.

System 18 may further include a long-range wireless communication transceiver that is configured for communication over longer distances through a cellular communications network 36 or satellite communication network 38 for vehicle navigation, diagnostic reporting, fleet management and other purposes. The transceiver may, for example, be configured for cellular communication according to either GSM, CDMA, UMTS or LTE standards and therefore include a standard cellular chipset for voice communications, a wireless modem (not shown) for data transmission, and a radio transceiver that transmits signals to and receives signals from a dual antenna for wireless communication with network 36. Using communication networks 36, 38, system 18 may be connected to a telecommunications network 40 and, through network 40, to various computing devices 42 including those used in fleet management of vehicle 10 and other vehicles in a fleet. Network 40 may include a public switched telephone network (PSTN) such as that used to provide hardwired telephony, packet-switched data communications, and the Internet infrastructure. One or more segments of network 40 could be implemented through the use of a standard wired network, a fiber or other optical network, a cable network, power lines, other wireless networks such as wireless local area networks (WLANs), or networks providing broadband wireless access (BWA), or any combination thereof. Computing devices 42 may comprise, for example, servers (including file servers, web servers, or network address servers) or client computing devices and may be used for a wide variety of purposes including, for example, accessing or receiving vehicle data for use in diagnosing and servicing vehicle 10, setting up or configuring vehicle 10, controlling vehicle functions and connecting the vehicle operator to human advisors, automated voice response systems, databases, and the like used in providing, for example, information, emergency or roadside assistance services and vehicle diagnostic services. In accordance with one aspect of the present teachings, computing devices 42 may be used by fleet managers to gather information from system 20 regarding operator fatigue and potential safety events.

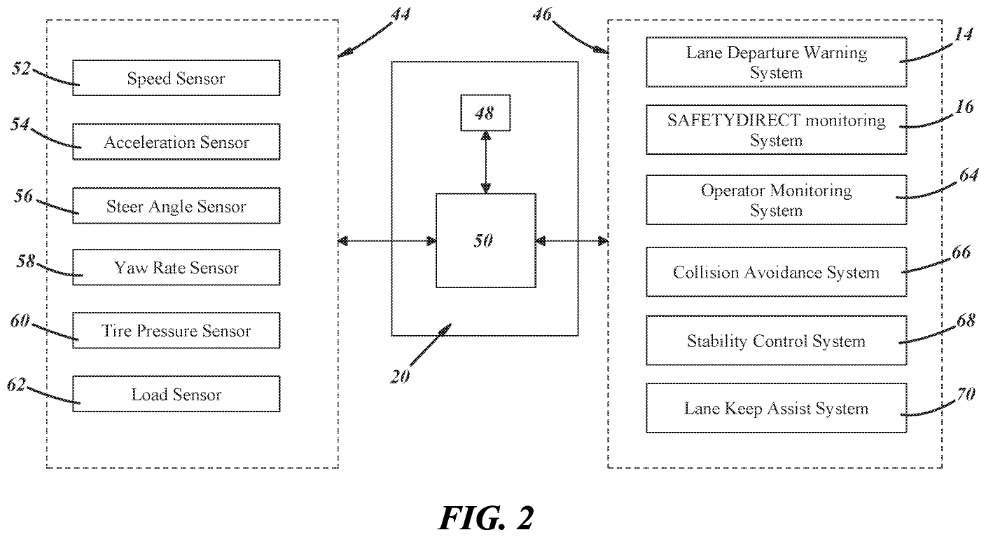

System 20 is provided to predict vehicle safety events for vehicle 10. In the illustrated embodiment, system 20 is shown separate from system 16. System 20 may, however, form a part of system 16. In the illustrated embodiment, system 20 is also shown as being on board vehicle 10. In an alternative embodiment, however, certain components of system 20 may be implemented in one or more computing devices 42 remote from vehicle 10 or the functionality of certain components of system 20 may be shared between components of vehicle 10 and components of one or more computing devices 42 as indicated by the dashed box 20′. Referring to FIG. 2, system 20 may be configured to receive signals and information/data from a variety of sensors 44 and systems 46 on vehicle 10 and may include a memory 48 and a controller 50. One or both of memory 48 and controller 50 may be located on vehicle 10, computing device 42 or a combination of the two. Further, the functionality of controller 50 described hereinbelow may be divided between controllers on vehicle 10 and computing device 42.

Sensors 44 are provided to measure or sense values or states associated with various operating conditions for vehicle 10, the environment in which vehicle 10 is operating, and/or the identity, actions and movements of the operator of vehicle 10. Sensors 44 generate sensor signals indicative of those values or states and may provide those signals to system 20. Sensors 44 may, for example, include a wheel speed sensor 52 that generates a signal indicative of the rotational speed of a wheel on vehicle 10 and, therefore, the speed of vehicle 10, an acceleration sensor 54 that generates a signal indicative of the acceleration or deceleration of vehicle 10 in either or both of the longitudinal or lateral directions (lateral acceleration may, for example, be used to assess whether the operator is actively engaged in maintaining vehicle 10 within the lane of travel 12 and may therefore be indicative of operator fatigue), a steer angle sensor 56 that generates a signal indicative of the steer angle of vehicle 10, a yaw rate sensor 58 that generates a signal indicative of the speed of rotation of vehicle 10 about a vertical axis, a tire pressure sensor 60 that generates a signal indicative of the pressure of one or more tires on vehicle 10, and a load sensor 62 that generates a signal indicative of the load on a trailer of vehicle 10. It should be understood that the sensors 52, 54, 56, 58, 60, 62 are exemplary and that sensors may be used to generate signals indicative of a variety of variables associated with the operation of vehicle 10, the environment in which vehicle 10 is operating and/or the identity, actions or movements of the operator of vehicle 10 including, for example, the position (angle) of the gas pedal in vehicle 10, actuation of the brake pedal in vehicle 10, the yaw angle of vehicle 10, the distance of vehicle 10 from lane markings for a lane of travel of the vehicle 10, the curvature of the road on which vehicle 10 is travelling or the lane of travel on the road, the presence of and/or content (e.g., speed limits) on road signs as detected by a camera on vehicle 10, or a following distance or relative speed between vehicle 10 and another vehicle in front of vehicle 10. Signals generated by sensors 44 may be provided directly to system 18, but also may be provided to and used by one or more of systems 46.

Systems 46 may also be provided to monitor the operating conditions of vehicle 10, the environment in which vehicle 10 is operating and/or the identity, actions and movements of the operator 10 and may be also be provided to control the operation of vehicle 10. Some or all of systems 46 may also comprise control systems for vehicle 10 that control aspects of the operation of vehicle 10. Systems 46 may provide signals to system 20 indicative of the operating conditions of vehicle 10, the environment in which vehicle 10 is operating and/or the identity, actions and movements of the operator of vehicle 10. One or more of systems 46 may also receive control signals generated by system 20 for controlling the operation of vehicle 10 in the event that system 20 predicts a safety event for vehicle 10. In accordance with the present teachings, systems 46 may include the lane departure warning system 14 and monitoring system 16 discussed hereinabove. In accordance with certain embodiments of system 18 disclosed herein, systems 46 may further include a biometric identification and operator monitoring system 64 including a camera (sometimes referred to as a driver facing camera) that is configured to capture images of the operator of vehicle 10 and the interior of the cabin in vehicle 10 and capture information regarding movements, angles, and relative directions of the operator's eyes (which may be open or closed) and head. Systems 46 may further include a collision avoidance system 66 that uses RADAR, LIDAR or similar sensors to determine the distance between vehicle 10 and other vehicles, pedestrians and road infrastructure, an anti-locking braking system and/or stability control system 68 that detect a loss of traction in vehicle 10, and a lane keep assist system 70 that assists in maintaining the vehicle 10 within a lane of travel. It should be understood that the above-identified systems are exemplary only and that systems 46 may include additional systems not illustrated herein including, for example, a tire pressure monitoring system, systems monitoring usage of individual vehicle components such as seat belts, turn signals and head lights, and control systems used to control the operation of one or more components in vehicle 10 including, for example, engine control systems, steering control systems and brake control systems.

Memory 48 may be provided to store data, data structures, software, firmware, programs, algorithms, scripts, and other electronic instructions. In accordance with one aspect of the present teachings, memory 48 may store programming instructions (i.e., software or a computer program) to implement a method for predicting vehicle safety events as discussed in greater detail below. Memory 48 may comprise a semiconductor memory device and may comprise a combination of volatile (e.g., random-access memory (RAM), dynamic random-access memory (DRAM), or static random-access memory (SRAM)) and non-volatile memory (e.g., read only memory (ROM), programmable read only member (PROM), erasable programmable read only memory (EPROM), electrically erasable programmable read only memory (EEPROM), flash memory) and may comprise a combination of permanent and rewritable memory. Although memory 48 is illustrated in FIG. 1 as being external to controller 50, it should be understood that memory 48 may be contained within controller 50. Further, although memory 48 is illustrated as a memory specific to system 20, it should be understood that memory 48 may form a part of another system in vehicle 10 such as system 14 or system 16 and that memory 48 may be subdivided among a plurality of systems such as systems 14, 16 and 20.

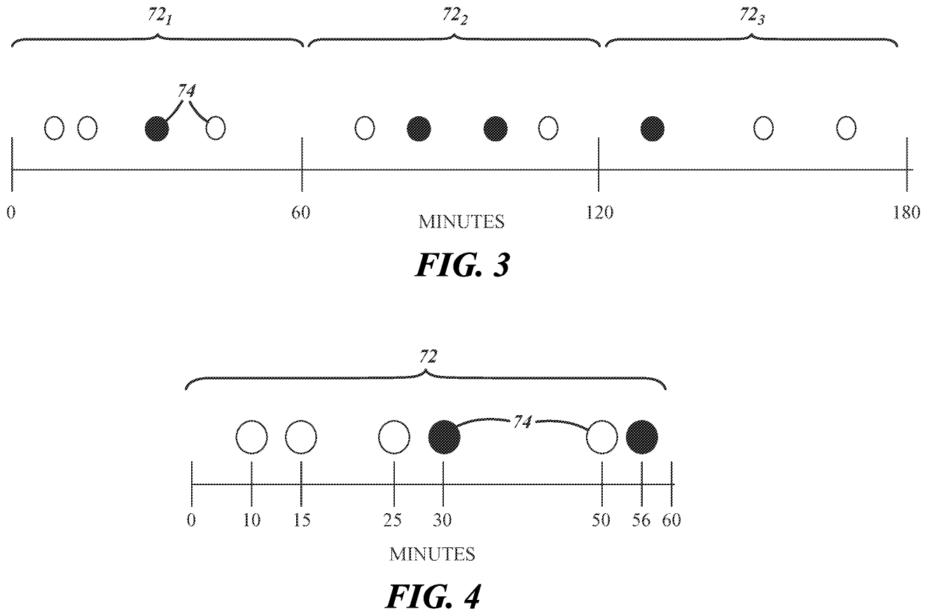

Referring to FIG. 3, in accordance with one aspect of the present teachings, memory 48 may store one or more datasets 72 for use by controller 50. Each dataset 72 includes information for various events 74 that occurred during a period of predetermined length. The predetermined length may comprise a predetermined length of time or a predetermined length of travel of vehicle 10. In the illustrated embodiment, for example, datasets 72₁, 72₂, and 72₃ include events that occurred during minutes 1-60 of travel, minutes 61-120 of travel and minutes 121-180 of travel, respectively. At minute 181, dataset 72₃ would comprise the “most recent dataset,” dataset 72₂ would comprise the “second most recent dataset 72” and dataset 72₃ would comprise the “third most recent dataset” as these terms are subsequently used herein. The datasets 72 stored in memory 48 may cover exclusive periods as illustrated in FIG. 3 or overlapping periods (e.g., the first dataset covering minutes 1-60 of travel, the second dataset covering minutes 31-90, the third dataset covering minutes 61-120, etc.) in which case an event 74 may be found in multiple datasets 72. The dataset 72 stored in memory 48 also may be temporally spaced or periodic (e.g., the first dataset covering minutes 1-60 of travel, the second dataset covering minutes 121-180, the third dataset covering minutes 241-300, etc.) or aperiodic (e.g., when a specific condition is detected (e.g., a narrow road) under which it is desired to obtain an indication of the condition of the operator). The datasets 72 may be organized in memory 48 in a conventional data structure that establishes a logical relationship between the datasets 72. In one embodiment, for example, a value may be associated with each dataset 72 to allow identification of individual datasets 72 and the relationship between any two datasets 72 in terms of time or travel distance of vehicle 10. For example, in embodiments where the predetermined length of the period for each dataset 72 is based on time and the predetermined length is an hour, each dataset 72 may be given a successive, increasing integer value with the first dataset covering minutes 1-60 assigned 1, the second dataset covering minutes 61-120 assigned 2, etc. In the illustrated embodiment, data sets 72₁, 72₂, and 72₃ may be associated with integer values 1, 2, and 3, respectively, in memory 48. Partially overlapping datasets 72 may be given intermediates values (e.g., 2.25 for a dataset 72 covering minutes 76-135).

In accordance with the present teachings, the events 74 in each dataset 72 will include lane departure events in which vehicle 10 unintentionally departed the lane of travel 12 during the period of predetermined length. Referring to FIG. 4, in one embodiment each dataset 72 may comprise information about lane departure events that have occurred over an hour of time. In the illustrated embodiment, six lane departure events occurred during the hour of time. The information for each lane departure event may include the time the event occurred. This time may either be the absolute time or relative to a frame of reference (e.g., 10 minutes since the start of the predetermined length of time). In the illustrated embodiment, lane departure events occurred 10, 15, 25, 30, 50 and 56 minutes into the hour. The information for each lane departure event may further include the travel distance for vehicle 10 when the event occurred. The travel distance may be the distance travelled during the lifetime of vehicle 10 (i.e., the odometer reading) or may be relative to another frame of reference (e.g., 10 kilometers since the most recent start or ignition of the power system of vehicle 10). The information for each lane departure event may further include an indication of the extent of departure from the lane of travel 12 by vehicle 10. The indication of the extent of departure may be a numerical value such as the distance of a point on vehicle 10 from the outboard edge of a lane marker 26, 28. In other embodiments, the indication of the extent of departure may be a numerical or other categorical value indicating that a point on vehicle 10 has departed from the lane of travel 12 by less than or more than a predetermined amount or is located within one of a plurality of ranges of positions (e.g., within 0-10 centimeters, 10-20 centimeters, etc. outboard of an edge of lane marker 26, 28). In the illustrated embodiment, open circles are indicative of lane departure events where vehicle 10 has departed the lane of travel 12 by less than a predetermined distance (hereinafter “minor lane departure events”) while filled in circles are indicative of lane departure events where vehicle 10 has departed the lane of travel 12 by more than the predetermined distance (hereinafter “major lane departure events”).

Each dataset 72 may also include information regarding events 74 other than lane departure events. In some embodiments, each dataset 72 further includes information regarding distance alert events in which a collision avoidance system 66 or adaptive cruise control system on vehicle 10 generates an alert or warning to the operator of vehicle 10 whenever either (i) a decrease in distance between vehicle 10 and another vehicle, pedestrian or other object occurs or (ii) a distance between vehicle 10 and another vehicle, pedestrian falls below a predetermined threshold distance. In some embodiments, each dataset 72 further includes information regarding operator movement events including eye opening and closing events and operator head pose change events in which operator monitoring system 64 generates signals indicative of a transition of operator's eyes between open and closed states or indicative of a change in the yaw, pitch, or roll angle of the operator's head). Other events 74 may include intentional lane changes and operator application of vehicle brakes which may be indicative of operator alertness. Each distinct type of event 74 may be assigned a unique event identification value that identifies the type of event 74 and this event identification value may be included among the information associated with an event 74 in the dataset 72 and in memory 48. Where the event identification value comprises a number, events 74 that are more likely to indicate operator fatigue may be assigned higher numbers. Therefore, for example major lane departure events may have a higher event identification value than minor lane departure events.

Each dataset 72 may further include information that may be indicative of operator fatigue, but that is not specific to an individual event 74. For example, each dataset 72 may also include information indicative of whether the dataset 72 was recorded during the day or night (with nighttime driving more likely to lead to operator fatigue), the weather conditions when the dataset 72 was recorded or other operational conditionals for vehicle 10 when the dataset 72 was recorded. Each dataset 72 may also include information regarding the direction of vehicle travel with the understanding that driving in a direction where the sun is in front of vehicle 10 may result in greater operator fatigue than driving in a direction where the sun is behind the vehicle 10. Each dataset 72 may also include information that aggregates information from individual events 74 rather than information about the individual events 74. For example, because operator movement events such as operator eye opening and closing events and operator head pose change events occur frequently, information regarding these events may be aggregated (e.g., total time during the period of predetermined length during which the operator's eyes are open and/or the average, median and standard deviation of yaw, pitch and roll angles of the operator's head during the period of predetermined length) and stored in dataset 72 rather than stored as individual events 74 in dataset 72.

Controller 50 is provided to analyze information in the datasets 72 to predict safety events for vehicle 10. Controller 50 may comprise a programmable microprocessor or microcontroller or may comprise an application specific integrated circuit (ASIC). In certain embodiments, controller 50 may include a memory (such as memory 48), a central processing unit (CPU), and an input/output (I/O) interface including a plurality of input/output pins or terminals through which controller 50 may receive a plurality of input signals and transmit a plurality of output signals. The input signals may include signals from memory 48, but may also include signals from other sensors 44 and systems 46 on vehicle 10 including system 18. The output signals may include signals to memory 48, but may also include signals to other sensors 44 and systems 46 on vehicle 10 including system 18. The output signals may also include signals to operator interface elements in vehicle 10 including display screens, surface projectors, and audio, visual and haptic indicators and to various vehicle control systems including collision avoidance system 66, stability control system 68, lane keep assistance system 70, engine or motor control systems, steering control systems and brake control systems.

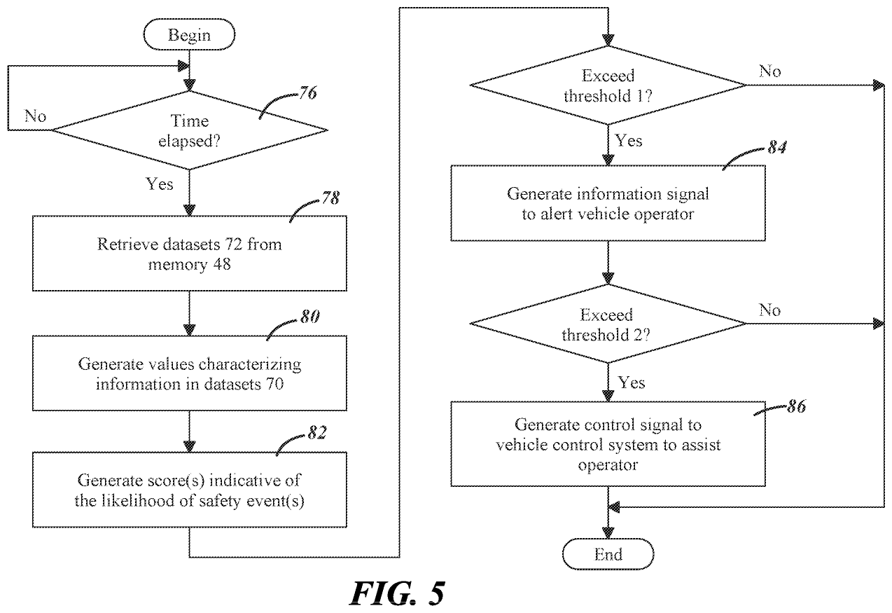

Referring now to FIG. 5, controller 50 may be configured with appropriate programming instructions (i.e., software or a computer program) to implement a method for predicting a vehicle safety event for vehicle 10. The method may begin with the step 76 of determining whether a predetermined amount of time has elapsed since the last time the method was performed. In one embodiment, controller 50 is configured to implement the method every fifteen (15) minutes. It should be understood, however, that this time may be varied and may be modified based on consideration of various factors including the availability of computational resources.

If a sufficient amount of time has elapsed since the last time the method was performed, the method may continue with the step 78 of retrieving one or more datasets 72 from memory 48. During the operation of vehicle 10, datasets 72 may be continuously formed beginning from the start of operation of vehicle 10. As discussed above, each dataset 72 will include information about events 74 occurring a period of predetermined length (time or distance). Each dataset 72 may further include information specific to the dataset 72 (e.g., identifying information and/or information that relates the dataset 72 to other datasets 72), information that may be indicative of operator fatigue, but that is not specific to an individual event 74, and aggregated information for certain types of events 74. In accordance with the present teachings, each dataset 72 contains information relating to lane departure events for vehicle 10 that occurred during a prior period of predetermined length including a time associated with the lane departure event, a travel distance associated with the lane departure event and an indication of the extent of the lane departure. Because these lateral movements of vehicle 10 may be indicative of operator fatigue, the movements may be used by controller 50 to predict safety events resulting from longitudinal movements of vehicle 10 that may also result from operator fatigue as discussed in greater detail below. It should be understood, however, each of dataset 72 may contain information relating to other types of events for vehicle 10 including some that relate to longitudinal movements of vehicle 10. For example, in one embodiment, each dataset 72 may optionally also include information for distance alert events in which a collision avoidance system 66 or adaptive cruise control system in vehicle 10 generates an alert to the operator or an operator assistance system on vehicle 10 that the distance between vehicle 10 and another vehicle, pedestrian or other object is decreasing and/or less than a predetermined distance. In other embodiments, each dataset 72 may include information regarding operator movements including operator eye opening and closing events and operator head pose change events (either as individual events 74 or aggregated) from operator monitoring system 64. Controller 50 preferably retrieves the dataset 72 stored in memory 48 from the most recently completed period of predetermined length prior to the current time or travel distance of vehicle 10. For example, if the predetermined length is an hour of time and the method is initiated 135 minutes into the trip, controller 50 may retrieve a dataset 72 covering minutes 76 to 135 of the trip. In embodiments where controller 50 retrieves multiple datasets 72, controller 50 would then preferably retrieve the dataset 72 for the next most recent period prior to that period and so on. In the example described above therefore, controller 50 would retrieve another dataset 72 covering minutes 16 to 75 of the trip. In general, at a given time t, controller 50 will retrieve datasets 72 of a predetermined length (e.g., an hour) ending at time t and then predict the likelihood of a safety event for vehicle 10 occurring during a certain period after time t.

After the set(s) of data 72 are retrieved, the method may continue with the step 80 of generating a plurality of values characterizing the information in the set(s) of data 70. Each value may characterize information relating to a single lane departure event (or other type of event 74) in the dataset 72 or characterize information relating to multiple lane departure events (or other type of event 74) in the dataset. Where the dataset(s) 72 include information for events 74 of different types (e.g., lane departure events and distance alert events), the values may characterize information relating to multiple events 74 of different types. Where controller 50 retrieves multiple datasets 72, the values may further characterize information relating to events 74 within different datasets 72. The values may also characterize other information in a dataset 72 described above including information in the dataset 72 that is not tied to a specific event 74 or type of event 74, aggregated information from a plurality of events 74, and information relating to the dataset 72 itself and that relates the dataset 72 to other datasets 72.

In one or more embodiments, controller 50 generates various time-based values that characterize information relating to a time associated with one or more events 74 in the dataset(s) 72. These time-based values may include the times of individual events 74 within the dataset 72, differences in times between multiple events 74 in the dataset 72 (i.e., gaps) or other types of values based on the times of the events 74 in the dataset 72 (e.g., differences in the length of gaps). For example, a linear regression may be performed on the differences in time between successive pairs of events 74 to generate a slope value indicative of increasing or decreasing temporal frequency of events 74. As an example, events 74 may occur at minutes 1, 17, 25, 29, 31 and 32 within an hour such that the gaps between events are 16, 8, 4, 2 and 1 minute, respectively, demonstrating an increasing frequency of events 74 and a corresponding decrease in the size of the gap over time. Differences in the length of the gaps are then obtained by taking each successive gap value and subtracting the prior gap value to obtain −8, −4, −2 and −1, respectively. The sign and magnitude of the average of the differences in the length of the gaps (i.e., −15/4 or −3.75) may be used to identify trends and the strength of those trends. Exemplary time-based values include the values described in the following paragraphs.

Avg_MinInHour is an average of the times at which the events 74 in a dataset 72 occurred. Its value may range between 0 and 59 minutes. A relatively low value will indicate that few events 74 occurred later in the period covered by the dataset 72 while a relatively high value will indicate that more events 74 occurred later in the period when operator fatigue would be expected to increase.

InHourAverageStamp is an average time at which the events 74 in a dataset 72 occurred relative to the start of a trip for vehicle 10. For a dataset 72 covering minutes 121 to 180 of the trip, if the average time of events within the hour is 47 minutes into the hour, Avg_MinInHour would be 47 while InHourAverageStamp would be 167. Because InHourAverageStamp also reflects the length of the trip, InHourAverageStamp may have more predictive power for severe events than Avg_MinInHour.

PrevHourInAvgStamp is an average time at which the events 74 in the second most recent dataset 72 occurred relative to the start of a trip for vehicle 10.

PrevHourAveGap is an average of the times between successive events 74 in the second most recent dataset 72. In computing this value, the gap between the first event 74 in the second most recent dataset 72 and the last event in the third most recent dataset 72 is included. In situations where a dataset 72 includes a single event 74, this value may be set to zero and/or ignored.

Min_MinInHour is the difference in time between the first event 74 in the dataset 72 and the time of the start of the dataset 72 (e.g., if the dataset 72 covers minutes 61 to 120 of a trip and the first event occurs at 68 minutes into the trip, Min_MinInHour would be 7).

Last_AbsoluteEventHour is the absolute time of day hour (e.g., 1 p.m. or 1300 hours) corresponding to the last event 74 in a dataset 72.

Avg_GapDiff is an average of the differences in length between (i) each gap between a pair of successive events 74 in the dataset 72 and (ii) the immediately preceding gap between the immediately preceding pair of successive events in the dataset 72. In an example where events occur at 10, 30, 45 and 55 minutes after the start of a dataset 72, the gaps between each pair of successive events are 20, 15 and 10 and the difference between each gap and the immediately preceding gap is −5 (i.e., 15-20) and −5 (i.e., 10-15) for an Avg_GapDiff of −5. A negative value indicates that the successive events are occurring closer in time and may be indicative of operator fatigue.

Median_GapDiff is the median value of the differences in length between (i) each gap between a pair of successive events 74 in the dataset 72 and (ii) the immediately preceding gap between the immediately preceding pair of successive events in the dataset 72.

First_Gap is the time between the first two events 74 in a dataset 72.

Last_Gap is the time between the last two events 74 in the dataset 72.

Max_Gap is the largest difference in time between successive events 74 in the dataset 72. In computing this value, the time difference or gap between the first event 74 in the dataset 72 and the last event is considered.

Min_gap is the smallest difference in time between events 74 in the dataset 72. In computing this value, the time difference or gap between the first event 74 in the dataset 72 and the last event in the second most recent dataset 72 is considered.

Avg_gap is the average of the differences in time between events 74 in the dataset 72. In computing this value, the time difference or gap between the first event 74 in the dataset 72 and the last event in the second most recent dataset 72 is considered.

Median_gap is the median length of the differences in time between lane departure events 74 in the dataset 72. In computing this value, the time difference or gap between the first event 74 in the dataset 72 and the last event in the second most recent dataset 72 is considered.

CGDifference is the time difference between (i) the centroid (mean) time of all minor lane departure events in the dataset 72 and (ii) the centroid (mean) time of all major lane departure events in the dataset 72. A nonzero value indicates a trend towards either major lane departure events or minor lane departure events as time progresses.

Max_ClusterTimeDifferences is the maximum time between successive lane departure events 74 in the dataset 72. This value is set to zero if there is one or less lane departure event 74 within a dataset 72.

Min_ClusterTimeDifferences is the smallest difference in time between lane departure events 74 in the dataset 72. This value is set to zero if there is one or less lane departure event 74 within a dataset 72.

Median_ClusterTimeDifferences is the median value of the times between successive lane departure events 74 in the dataset 72. This value is set to zero if there is one or less lane departure event 74 within a dataset 72.

StDev_ClusterTimeDifferences is the standard deviation of the differences in time between lane departure events 74 in the dataset 72. This value is set to zero if there are two or fewer lane departure events 74 in the dataset 72.

In one or more embodiments, controller 50 generates various distance-based values characterizing information relating to a distance associated with one or more events 74 in the dataset(s) 72. These distance-based values may include the distances of individual events 74 within the dataset 72, differences in distance between multiple events 74 in the dataset 72 or other types of values based on the distances associated with the events 74 in the dataset 72. For example, a linear regression may be performed on the differences in travel distance between successive pairs of events 74 to generate a slope value indicative of increasing or decreasing spatial frequency of events 74. Exemplary distance-based values include the values described in the following paragraphs.

Min_EventDistance is the travel distance of vehicle 10, relative to when the trip started (i.e., when the vehicle 10 was started), when the first event 74 in the dataset 72 occurred.

Max_EventDistance is the travel distance of vehicle 10, relative to when the trip started (i.e., when the vehicle 10 was started), when the last event 74 in the dataset 72 occurred.

In one or more embodiments, controller 50 generates event number-based values characterizing information relating to the number of events 74 in the datasets 72. Exemplary number-based values include the values described in the following paragraphs.

SumIsLDWFam is the number of lane departure events in the most recent dataset 72.

PrevHoursLDWFam is the number of lane departure events in the second recent dataset 72.

PrevHourLDWFam2 is the number of lane departure events in the third most recent dataset 72.

A trend of increasing lane departure events from older datasets 72 to the most recent dataset 72 may indicate operator fatigue. If any of the above datasets 72 does not exist yet (e.g., the current trip of vehicle 10 has only recently begun), the corresponding value is set to zero. If the dataset 72 exists, but is truncated from the predetermined length (e.g., if the vehicle is 105 minutes into the trip, the most recent dataset 72 would cover minutes 31 to 90 while the second most recent dataset 72 would only cover minutes 1 to 30), controller 50 may extrapolate from the information in the dataset 72 (e.g., by doubling the number if the dataset 72 only includes events over a period that is half of the predetermined length) or ignore the truncated dataset 72.

In one or more embodiments, controller 50 generates speed-based values characterizing information relating to the speed of vehicle 10 between events 74 in the datasets 72. Exemplary speed-based values include the values described in the following paragraphs.

ApproxSpeed is an estimate of the speed of vehicle 10 over the period of predetermined length calculated as the distance of travel of vehicle 10 between first and last events 74 in the period divided by the time between the first and last events 74.

In one or more embodiments, controller 50 may generate various values characterizing information relating to the dataset 72 as a whole. These values may include the values described in the following paragraphs.

SinceTripStart is the number assigned to a dataset 72. As discussed above, this number will be indicative of the length (in terms of time or distance) of a trip of vehicle 10 (i.e., the time or distance since vehicle 10 was started).

In one or more embodiments, controller 50 may generate various event type-based values characterizing information relating to the type of events 74 in the dataset 72. These values may include the values described in the following paragraphs.

Avg_EventID is the average value of the assigned event identification values for events 74 in the most recent dataset 72. For example, minor lane departure events may have an event identification value of 2 and major lane departure events may have an event identification value of 128. If the dataset 72 includes three minor lane departure events and one major lane departure events, Avg_EventID would be calculated as (3*2+1*128)/4=33.5. An alternative value may quantify the percentage of a particular type of event 74 relative to the total number of events 74 within a dataset 72.

PrevHourAvgEvntID is the average value of the assigned event identification values for events 74 in the second most recent dataset 72.

PrevHourSevereRatio is the ratio of the number of major lane departure events to the number of minor lane departure events in the second most recent dataset 72. If there are no major lane departure events and/or no minor lane departure events in the dataset 72, this value may be set to zero or a large default value.

PrevHourSevereRatio2 is the ratio of the number of major lane departure events to the number of minor lane departure events in the third most recent dataset 72. If there are no major lane departure events and/or no minor lane departure events in the dataset 72, this value may be set to zero or a large default value.

Sum_isLDW is the number of minor lane departure events in the most recent dataset 72.

Sum_lsxLDW is the number of major lane departure events in the most recent dataset 72.

Sum_lsDA is the number of distance alert events in the most recent dataset 72.

In one or more embodiments, controller 50 may generate various event transition type-based values characterizing information relating to the transitions between different types of events 74 in the dataset 72. For example, controller 50 may compute a value indicating the total number of transitions between events of different types within a dataset 72, the transitions between specific event types including, for example, transitions from minor lane departure events to major lane departure events and transitions from major lane departure events to minor lane departure events, and/or values relating the number of a certain type of event transition to the total number of event transitions in a dataset 72.

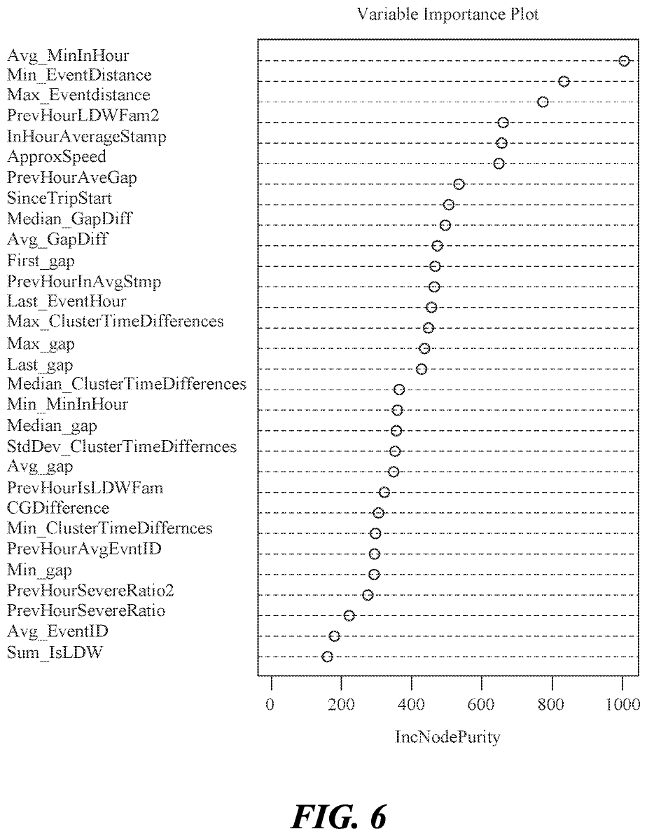

Applicant has determined through testing that certain values or combinations of values described above are more predictive of vehicle safety events than others. In particular, among several of the values listed above, the values may be ranked in terms of predictive value for vehicle safety events from the most predictive to least predictive as illustrated in FIG. 6 and as ordered in the following list: (1) Avg_MinInHour; (2) Min_EventDistance; (3) Max_EventDistance; (4) PrevHourLDWFam2; (5) InHourAverageStamp; (6) ApproxSpeed; (7) PrevHourAveGap; (8) SinceTripStart; (9) Median_GapDiff; (10) Avg_GapDiff; (11) First_Gap; (12) PrevHourInAvgStamp; (13) Last_EventHour; (14) Max_ClusterTimeDifferences; (15) Max_Gap; (16) Last_Gap; (17) Median_ClusterTimeDifferences; (18) Min_MinInHour; (19) Median_gap; (20) StDev_ClusterTimeDifferences; (21) Avg_gap; (22) PrevHoursLDWFam; (23) CGDifference; (24) Min_ClusterTimeDifferences; (25) PrevHourAvgEvntID; (26) Min_gap; (27) PrevHourSevereRatio2; (28) PrevHourSevereRatio; (29) Avg_EventID; (30) Sum_isLDW.

It should be understood that the above-identified values are exemplary only and that controller 50 may generate other values to characterize the information in each dataset 72. For example, to the extent distance alert events or other types of events aside from lane departure events are included in the datasets 72, values may be generated by controller 50 similar to those described above relating to each specific type of event alone or encompassing multiple types of events. To the extent datasets 72 include information about operator eye opening and closing events from operator monitoring system 64, controller 50 may generate values indicative of the amount or the time of particular eye opening and closing events within the period of predetermined length (e.g., the time of the first eye closing event), the percentage of time the operator's eyes are open or closed (or open or closed more longer than a predetermined time) over the period of predetermined length, the average length (time or distance) the operator's eyes are open or closed over the period of predetermined length, or trends regarding eye opening and closing over the period of predetermined length (e.g., if the eye closing events are growing in number of length). To the extent datasets include information about operator head pose change events from operator monitoring system 64, controller 50 may generate values indicative of the average, median, standard deviation, Hjorth parameters (activity, mobility, complexity) or Fourier spectral values of one or more of the yaw, pitch and roll angles of the operator's head, the speed of movement of the operator's head in various directions, the amount of time the operator is looking left and/or right (e.g., checking side mirrors) during the period of predetermined length, whether the operator is looking left or right prior to a lane departure or when the lane of travel 12 is curving, or trends regarding head pose over the period of predetermined length (e.g., is the operator's head sinking forward over time?). Controller 50 may also generate values that relate eye opening and closing events or head pose change events to events relating to vehicle travel such as lane departure events.

In some embodiments, controller 50 may generate inter-event speed values relating to inter-event speeds (i.e., the extent of travel of vehicle 10 between successive events 74 in the dataset 72 divided by the time between the events) including the average of inter-event speeds in a dataset 72, the median of inter-event speeds in a dataset 72, the maximum and minimum inter-event speeds in a dataset 72 and the standard deviation of the inter-event speeds in a dataset 72. Relatively large inter-event speeds may be indicative of faster travel and a greater likelihood of a safety event. The inter-event speeds for a given dataset 72 may include the inter-event speed between the first event in the dataset 72 and the last event for the immediately preceding dataset 72. Controller 50 may also generate values based on differences in inter-event speeds. Inter-events speeds of 60, 40, 20, 40 evidence that the vehicle 10 slowed before the second and third events and increased in speed before the fourth event. From the differences in the interevent speeds (i.e., −20, −20, +20), an average of the absolute values of the differences (20+20+20/3=20) or the actual values of the differences (−20−20+20/3=−6.67) may be used to indicate trends in vehicle speed.

In some embodiments, controller 50 may generate cluster-based values based on clustering certain events within a dataset 72. For example, a cluster of lane departure events within a dataset 72 may be defined to include events 74 that would occur within a predetermined length of time or travel distance. If the predetermined length of time is thirty (30) seconds and a second lane departure event occurs fifteen (15) second after a first lane departure event and a third lane departure event occurs twenty-five (25) seconds after the second lane departure event, a cluster of three lane departure events would be established. Values could then be derived based on these clusters including the number of clusters in an hour. When establishing clusters of events 74, the clusters may be established based on events within a single dataset 72 or may also consider events 74 from multiple datasets.

The method may further include the step 82 of generating, responsive to the plurality of values, scores indicative of the likelihood that various types of safety events for vehicle 10 will occur. As noted earlier, Applicant has determined that lateral movements of vehicle 10 as indicated in lane departure events may effectively predict operator fatigue and allow prediction of more significant safety events resulting from longitudinal movements of vehicle 10. Therefore, controller 50 may use the values obtained in step 80 to calculate scores indicative of the likelihood that different types of safety events resulting from longitudinal movement of vehicle 10 will occur including, for example, an excessive braking action by the operator of vehicle 10, an emergency braking action by a collision avoidance system 66 or other autonomous emergency braking system, issuance of a forward collision warning to an operator of vehicle 10 regarding a possible collision between vehicle 10 and another vehicle, pedestrian or object as vehicle 10 moves within lane of travel 12, or a loss of stability as lane of travel 12 curves.

Controller 50 may be configured to generate the scores using a machine learning algorithm known as a Random Forest Classifier (in alternative embodiments, a Linear Discrimination Classifier and/or a Logistic Regression Classifier may be used). This algorithm includes a plurality of binary decision trees that are formed using positive and negative training data. Controller 50 may be trained using datasets 72 recorded during the operation of vehicle 10 and/or other vehicles and the prior occurrence or absence of safety events during the operation of vehicle 10 and/or other vehicles. In one embodiment, following the occurrence of a safety event, the dataset 72 for the most recent period of predetermined length is used as positive training data (i.e., the events 74 recorded during the dataset 72 may be predictive of a safety event). Conversely, if no safety event has occurred, the dataset 72 for the most recent period of predetermined length is used as negative training data (i.e., the events 74 recorded during the dataset 72 are not predictive of a safety event). Because safety events are rare, training data is preferentially balanced so that approximately equal amounts of positive and negative training data are used in training controller 50. To the extent that the datasets 72 do not include certain information such as the identity of the operator of vehicle 10, the location where an event 74 occurred, the date, month or year an event 74 occurred, the direction of travel of vehicle 10 or the weather conditions when an event 74 occurred, etc. the scores generated by controller 50 will be agnostic to this information. It should be understood, however, that the datasets 72 could be formed in a manner to include the aforementioned information and other information. It should also be understood that controller 50 may implement a plurality of different specialized Random Forest Classifiers using different data from a dataset 72 or datasets 72 (although some or all of the same data from the dataset 72 or datasets 72 may be used in each classifier). For example, in one embodiment controller 50 may implement one generalized classifier directed to predicting the likelihood any of a plurality of different sever events will occur and, if the classifier generates a score exceeding a threshold indicative of a safety event, controller 50 will implement another, more specialized classifier directed to predicting the likelihood that a particular severe event will occur to see if the additional classifier will also generate a score exceeding the threshold.

During performance of the method, each decision tree takes one or more of the values computed in step 80 as inputs and applies predetermined binary tests to those values to generate an output. For example, a decision tree may ask whether a value is greater than a predetermined threshold with the threshold learned during training. Each decision tree may include a single branch applying tests to a single value computed in step 80 or multiple branches applying tests to the same value or multiple values computed in step 80. Further, each value computed in step 80 may be used in any number of the decision trees. The output of each decision tree is a binary output value of zero (0) or one (1). The outputs of the decision trees are then weighted based on the number of decision trees. Therefore, if the algorithm includes five hundred (500) decision trees, the output value of any one decision tree is weighted by 0.002. The output values of all of the decision trees are summed to produce a final score between zero (0) and one (1).

The method may continue with steps 84, 86 intended to mitigate the likelihood of a safety event in vehicle 10. In step 84, controller 48 generates an information signal configured to cause an alert system on vehicle 10 to alert the operator regarding the potential for a safety event if the score exceeds a first threshold. The information signal may cause an operator interface in vehicle 10 to generate a visual, audio or haptic alert to the operator. In step 86, controller 48 may generate a control signal configured to cause a control system on vehicle 10 to change an operation of vehicle 10 if the score exceeds a second threshold greater than the first threshold. For example, controller 50 may generate a control signal to an engine control system, steering control system such as lane keep assistance system 70 or brake control system such as stability control system 28 to cause a change in operation of vehicle 10 and assist the operator in avoiding a potential safety event. The thresholds may be established through testing to minimize the number false positives and false negatives regarding potential safety events. In an alternative embodiment, controller 48 may average multiple scores obtained of a predetermined period of time or vehicle travel distance and implement steps 84 and/or 86 only if the average score exceeds the given threshold in order to reduce potential noise in the data. In yet another alterative embodiment, controller 48 may be configured to implement steps 84 and/or 86 even if a score does not exceed the corresponding threshold if a predetermined number of scores obtained over a predetermined period of time or vehicle travel distance are close to the threshold (e.g., within a predetermined distance below the threshold) and/or are increasing over the predetermined period of time or vehicle travel distance indicating an increasing level of fatigue and the likelihood of a safety event.

A system 20 and method for predicting vehicle safety events in accordance with the present teachings represents an improvement as compared to conventional systems and methods. In particular, the system 20 and method make use of lateral movements of the vehicle 10 and, in particular, lane departure events, as an indication of operator fatigue in order to predict the likelihood of safety events such as collisions resulting from longitudinal movement of the vehicle 10.

While the invention has been shown and described with reference to one or more particular embodiments thereof, it will be understood by those of skill in the art that various changes and modifications can be made without departing from the spirit and scope of the invention.

What is claimed is:

1. A system for predicting a safety event for a vehicle, comprising:
a memory; and,
a controller configured to
retrieve a first dataset from the memory, the first dataset including information about one or more lane departure events in which the vehicle departed a lane of travel for the vehicle and that occurred during a first prior period of predetermined length, the information for each lane departure event including a time of the lane departure event, a travel distance of the vehicle when the lane departure event occurred, and an indication of the extent of departure from the lane of travel by the vehicle,
generate a plurality of values characterizing the information in the first dataset; and
generate, responsive to the plurality of values, a score indicative of a likelihood that a safety event of a first type for the vehicle will occur.

2. The system of claim 1 wherein the safety event comprises an event relating to travel of the vehicle in in the direction of the lane of travel.

3. The system of claim 1 wherein the controller is further configured to generate, responsive to the plurality of values, a score indicative of a likelihood that a safety event of a second type for the vehicle will occur.

4. The system of claim 1 wherein the period of predetermined length comprises a predetermined length of time.

5. The system of claim 1 wherein the period of predetermined length comprises a predetermined length of travel of the vehicle.

6. The system of claim 1 wherein the first dataset further includes information regarding one or more operator movement events that occurred during the first prior period of predetermined length, the one or more operator movement events including at least one of an eye opening event, an eye closing event and a head pose change event.

7. The system of claim 1 wherein the plurality of values include a ratio of a number of major lane departure events in which the vehicle departed the lane of travel by more than a predetermine distance to a number of minor lane departure events in which the vehicle departed the lane of travel by less than the predetermined distance in the first dataset.

8. The system of claim 1 wherein the controller is further configured to retrieve a second dataset from the memory, the second dataset including information about one or more lane departure events in which the vehicle departed a lane of travel for the vehicle and that occurred during a second prior period of predetermined length prior to the first prior period of predetermined length, the information for each lane departure event including a time of the lane departure event, a travel distance of the vehicle when the lane departure event occurred, and an indication of the extent of departure from the lane of travel by the vehicle and wherein the controller is configured to generate the plurality of values characterizing the information in the first and second datasets.

9. The system of claim 1 wherein the controller is further configured to generate an information signal configured to cause an operator interface on the vehicle to alert an operator if the score exceeds a first threshold.

10. The system of claim 9 wherein the controller is further configured to generate a control signal configured to cause a control system on the vehicle to change an operation of the vehicle if the score exceeds a second threshold greater than the first threshold.

11. A method for predicting a safety event for a vehicle, comprising:
retrieving a first dataset from a memory, the first dataset including information about one or more lane departure events in which the vehicle departed a lane of travel for the vehicle and that occurred during a first prior period of predetermined length, the information for each lane departure event including a time of the lane departure event, a travel distance of the vehicle when the lane departure event occurred, and an indication of the extent of departure from the lane of travel by the vehicle,
generating a plurality of values characterizing the information in the first dataset; and
generating, responsive to the plurality of values, a score indicative of a likelihood that a safety event of a first type for the vehicle will occur.

12. The method of claim 11 wherein the safety event comprises an event relating to travel of the vehicle in in the direction of the lane of travel.

13. The method of claim 11, further comprising generating, responsive to the plurality of values, a score indicative of a likelihood that a safety event of a second type for the vehicle will occur.

14. The method of claim 11 wherein the period of predetermined length comprises a predetermined length of time.

15. The method of claim 11 wherein the period of predetermined length comprises a predetermined length of travel of the vehicle.

16. The method of claim 11 wherein the first dataset further includes information regarding one or more operator movement events that occurred during the first prior period of predetermined length, the one or more operator movement events including at least one of an eye opening event, an eye closing event and a head pose change event.

17. The method of claim 11 wherein the plurality of values include a ratio of a number of major lane departure events in which the vehicle departed the lane of travel by more than a predetermine distance to a number of minor lane departure events in which the vehicle departed the lane of travel by less than the predetermined distance in the first dataset.

18. The method of claim 11, further comprising retrieving a second dataset from the memory, the second dataset including information about one or more lane departure events in which the vehicle departed a lane of travel for the vehicle and that occurred during a second prior period of predetermined length prior to the first prior period of predetermined length, the information for each lane departure event including a time of the lane departure event, a travel distance of the vehicle when the lane departure event occurred, and an indication of the extent of departure from the lane of travel by the vehicle and wherein the plurality of values characterize the information in the first and second datasets.

19. The method of claim 11, further comprising generating an information signal configured to cause an operator interface on the vehicle to alert an operator if the score exceeds a first threshold.

20. The method of claim 19, further comprising generating a control signal configured to cause a control system on the vehicle to change an operation of the vehicle if the score exceeds a second threshold greater than the first threshold.
